(19) United States
(12) Patent Application Publication
(10) Pub. No.: US 2007/0296243 A1
(43) Pub. Date: Dec. 27, 2007

(54) Adjusting system of a motor vehicle for the adjustment of a closing part for the closure of an opening of a motor vehicle body

(76) Inventors: Guido Borrmann, Herten (DE); Alwin Macht, Ebensfeld (DE); Georg Scheck, Weitramsdorf (DE); Andreas Johann, Wermelskirchen (DE); Andreas Heinrich, Wuppertal (DE); Matthias Hoffmann, Coburg (DE); Andrea Bauersachs, Ebersdorf (DE)

Correspondence Address: Jacob Eisenberg, Seerainstrasse 3a, Steckborn, CH-8266, omitted

(21) Appl. No.: 11/474,525

(22) Filed: Jun. 26, 2006

(51) Int. Cl. B60J 5/00

(52) U.S. Cl. 296/146.4

(57) ABSTRACT

An adjusting system of a motor vehicle for the adjustment of a closing part is disclosed. The system includes

a first and second casing extending oblong in a length-wise direction. The second casing has a smaller cross section than the first casing and is arranged within the first casing to be adjustable in a length-wise direction. A spindle for the relative adjustment of a first casing to the second casing is included and arranged within either or both of the first and second casings.

The system also includes an electromotor and a transmission connected with either or both of the spindle and second casing. In addition, at least one spring is arranged within either or both of the first and second casings and operates length-wise, such that one of the casings is attached on the side of the motor vehicle body and another of the casings is attached to the closing side.

### BACKGROUND OF THE INVENTION

The present invention relates to an adjusting system of a motor vehicle for the adjustment of a closing part for the closure of an opening of a motor vehicle body.

### SUMMARY OF THE INVENTION

According to the present invention, an adjusting system of a motor vehicle for the adjustment of a closing part between an opened and closed position is provided. The closing part thereby serves as a lock for an opening of a motor vehicle body. Such a closing part may be, for example, a rear flap, trunk deck, an engine deck, a window pane, a sliding door or a swing door.

The adjusting system thereby comprises several components which are connected in such a way that preferably, a compact construction is achieved.

A first casing of the adjusting system extends in a lengthwise direction. A second casing also extends in the same lengthwise direction. The second casing comprises a lesser cross section than the first casing and is at least partially and adjustably arranged within the first casing in its lengthwise direction. The first and second casings may comprise the same cross section so that the second casing is run on bearings which are movable within the first casing in a lengthwise direction. Advantageously, the first and second casings comprise a round cross-section and may be tubular-shaped.

Furthermore, the adjusting system comprises a spindle for the relative adjustment of the first casing to the second casing, the spindle being arranged within the first and/or second casing. Different spindle types, such as a planetary mill spindle, a ball bearing spindle or a trapezoid spindle may be used. During an adjustment of the closing part, the spindle moves relatively to at least one of the two casings in a lengthwise direction.

A characteristic feature of the invention is a compact structure such that an electro motor and a transmission of the adjusting system are fastened at the first and/or second casing and further connected with the spindle. By way of example, connection a power carried over by the transmission and released by the electro motor activates the spindle or the spindle nut arranged on the spindle to effect the connection. Therefore, the actuation from the electro motor and transmission and the adjusting mechanism, which is provided from at least the spindle, are integrated into a structure unit with the first and second casing. Therefore, the electro motor is fastened neither at the body nor at the closing part.

Furthermore, at least a spring of the adjusting system is provided and arranged within the first and/or casing and further operates in a lengthwise direction. Preferably, the spring force operates in an “open” direction. One casing is fastened on the side of the body and the other casing is fastened on the side of the locking side to carry over the adjusting power to the closing part and to enable a position adjustment of the closing part.

Any motor type can be used as an electro-motor. The electro-motor may be a mechanically or electrically commutated motor, such as a synchronous motor. A part of the first or second casing is advantageously arranged in a double function of the electro-motor.

For example, a casing wall may be a magnetic inference of the electro-motor as well as a dissipator for control components.

In another embodiment of the present invention, the electro-motor and transmission are arranged within the first casing. The transmission may be fastened opposite to the first casing above the attachment of the electro motor against radial rotation. The arrangement within the first casing then enables a compact structure, especially when the motor shaft of the electro-motor motor and the spindle are developed parallel and matched in alignment. The electro-motor and the transmission may additionally or alternatively be arranged within the first casing. The transmission above the attachment of the electro-motor is fastened against axial shifting within the first casing. By way of another embodiment, the first casing forms part of the transmission by its multiple functions and comprises a gear into which the planetary gearwheels comb cuts.

In another embodiment of the present invention, the transmission is developed in a non-self-locking manner, so that a force effecting the transmission on the drive side leads to a transmission motion without further arrangements. In addition, an adjusting mechanism is provided by the spindle which is developed in a non-self-locking manner so that a force activating the second casing and therefore the closing part leads to an adjusting motion of the spindle. The adjusting mechanism may comprise a spindle nut cooperating with the spindle.

To avoid an unwanted adjustment of the adjusting position of the closing part, a brake is provided, in an advantageous further embodiment of the invention, which is attached at the first and/or second casing and is effectively connected with the transmission and/or electro-motor. Partial functions of the brake can advantageously be affected by sections of the first and/or second casing. By way of another embodiment, the braking effect of the brake can be cancelled by either a manual dynamic effect on the closing part or by an electro-motor force of the electro-motor.

Another embodiment of the present invention comprises a sensory device provided for the sensibility of the adjustment, the device being attached at the first and/or second casing and effectively and particularly connected with a driving power of the electro-motor. By way of example, a hall sensor may be used as a sensor which cooperates with a magnet placed on a motor shaft to sense the rotation of the motor shaft.

In principle, it is possible to actuate a spindle nut by electro-motive force and to run the spindle with torsion strength on bearings. In another embodiment of the present invention, the spindle is actuated by the electro-motor and the transmission for a spindle rotation.

Another embodiment of the invention comprises a spindle and arranged on a trapezoid spindle whereby the adjusting mechanism from the trapezoid spindle and spindle nut is developed in a non-self-locking manner. A preferred embodiment provides for the relative adjustment of the first casing to the second casing, one of the casings is connected with the spindle nut axially and stationary and the other of the casings with the spindle axially and stationary. The connection may be a fixation.

According to another embodiment of the invention, a first end of the spring, referring to the first casing, is run on bearings which are stationary in a lengthwise direction; and a second end of the spring, referring to the second casing, is run in a lengthwise direction. Different spring types, such as spiral springs, tension springs, pressure springs, or gas pressure springs, can be used as springs whereby several different springs can also be combined. Preferably, at least two springs are in parallel and connected in series, whereby the springs in a particularly advantageous formation of the invention are radial and at least partially interlaced.

A further embodiment of the invention provides a bearing for the fixation of the first and/or second casing at the body such as at the closing part, whereby the bearing is preferably a pivot and/or a drag bearing.

A further embodiment of the invention is an integration of at least one part of the control electronics into the first and/or second casing. In a further embodiment of the invention, at least one power switch is provided, such as a power semiconductor, which can be or is electrically connected for control. Preferably, the power switch is arranged within the first casing and advantageously and thermally connected with the first casing so as to affect heat loss. Preferably, cables for the energy supply of the electro-motor and/or for the signal transmission, especially of sensor signals, are arranged within the first and/or second casing.

### BRIEF DESCRIPTION OF THE SEVERAL VIEWS OF THE DRAWINGS

In the following, the invention is further explained according to drawings and examples embodiments. According to the drawings,

FIG. 1 depicts a view of a rear flap in an opened position,

FIG. 2 depicts an external view of a rear flap adjusting system,

FIG. 3 depicts a sectional view through the rear flap adjusting system, and

FIG. 4 depicts a detailed view of the sectional view.

### DETAILED DESCRIPTION OF THE INVENTION

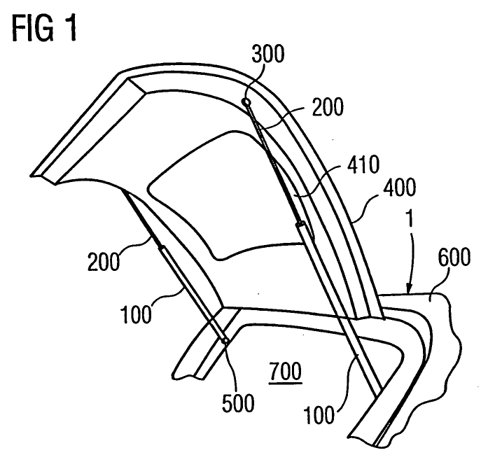

A three-dimensional detailed view of a motor vehicle 1 with an open rear flap 400 is shown in FIG. 1. The body 600 and the lockable opening 700 through the rear flap 400 in the body 600 of the motor vehicle 1 are only shown schematically. Apart from an external metal sheet, the shown rear flap 400 comprises a lower-able window pane 410 and an adjusting system with a first casing 100, a second casing 200, a first bearing 300 and a second bearing 500. Two such adjusting systems are shown in FIG. 1 which together affects an adjustment of the rear flap 400 between a closed position and an open position.

Further examples embodiments, not shown in the figures, provide for an adjusting system of a motor vehicle for the adjustment of another closing part, such as a rear flap 400. Here the adjusting system can be used for the adjustment of a trunk deck, a sliding or swinging door to close an opening of a motor vehicle body.

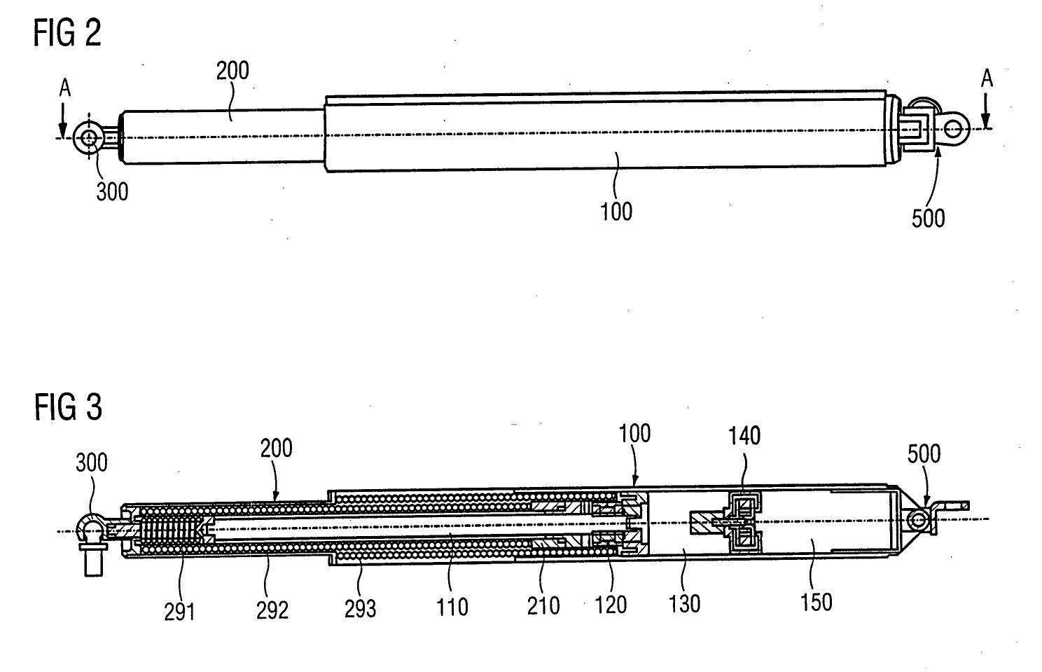

An adjusting system if depicted in a detailed view in FIG. 2. The adjusting system comprises a first oblong casing 100 extending along a lengthwise direction in the form of an external tube 100. A second casing 200, also in the form of an external tube 200, also extends oblong along the same lengthwise direction. The second external tube 200 comprises a smaller cross section than the first external tube; and the second external tube 200 is arranged at least partially and adjustably within the first external tube 100 in the mentioned lengthwise direction.

The first external tube 100 is attached on the side of the body, while the second external tube 200 is fastened on the side of the rear flap. A respective first and second bearing 300 and 500 are provided for the attachment in the depicted embodiment. The first bearing 500 is accordingly affixed on the first external tube 100 and may comprise two universal joints. The second bearing 300, which is affixed at the second external tube 200, may comprise a ball socket.

FIG. 3 comprises a sectional view through an adjusting system of FIG. 2. An electro-motor 150, a brake 140, a two stage planetary transmission 130, and an adjusting mechanism with a six-gear trapezoid spindle 110 and a spindle nut 210 rotating and running on a trapezoid spindle 110, are arranged at least partially within the first external tube 100. These elements, as shown in FIG. 3, influence the dynamic efficiency chain of the electro motor 150 on the adjustment of the rear flap 400. A brake 140 operates between the electro-motor 150 and the planetary transmission 130, which makes it possible for the braking to be cancelled either by a manual dynamic effect on the rear flap 400 or by the electro-motor force of the electro-motor 150. The brake 140 is thereby integrated within the first external tube 100 between the electro-motor 150 and the planetary transmission 130.

If the electro-motor 150 is, for example, controlled by an energy field efficiency transistor, not shown in FIG. 3 but preferably also located within a first external tube 100, the moment given off by the electro-motor 150 minus a lower friction of the brake 140 is transmitted on the two stage planetary transmission 130. The moment carried over by the planetary transmission 130 is given off to the trapezoid spindle 110 which is turning in dependence of the current of the electro-motor 150.

The spindle nut 210 is adjusted in an axial direction by the turning of the trapezoid spindle 110. The spindle nut 210 cooperates with the second external tube 200 in such a way that the second external tube 200 is adjusted in the same direction as the spindle nut 210. The spindle nut 210 may be fixated at the second external tube 200 or at a part firmly connected with the second external tube 200.

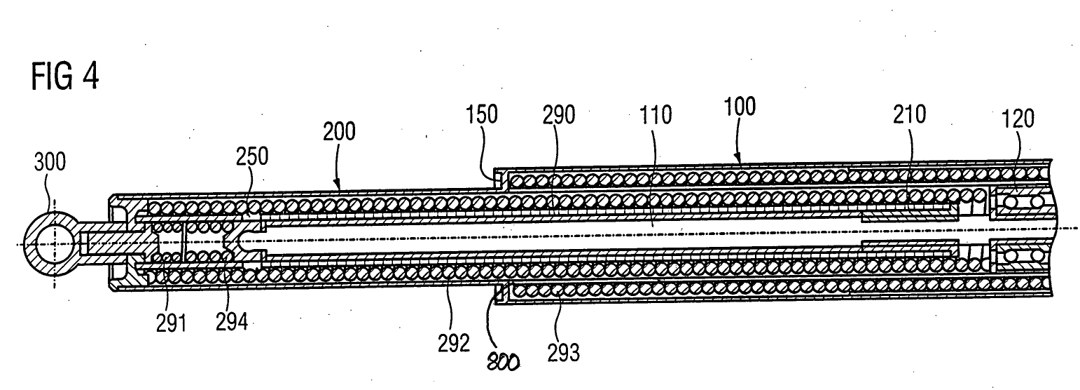

A cut-out of the sectional view of FIG. 3 is shown, enlarged, in FIG. 4. FIG. 4 depicts a spindle control 250 and an angular ball bearing 120 for the bearing of the turnable spindle 110. A connecting ring 160 is provided between the first external tube 100 and the second external tube 200. The first external tube 100 and the second external tube 200 are preferably controlled by turning in opposite directions.

Several springs 291, 292, 293 and 294 are arranged within the two external tubes 100, 200, whereby at least two of the springs 291, 292, 293 or 294 are switched in series and/or at least two of the springs 291, 292, 293 294 in parallel. All springs 291, 292, 293 and 294 thereby operate in a length-wise direction to support an opening of the rear flap 400 against the weight of the rear flap 400. Additionally, at least a guiding element 290 is preferably provided for the control of the spring motion.

In the example embodiment of FIG. 3, a switch-able brake is provided in the dynamic efficiency chain between the motor 150 and the spindle 110, which can also be described as a clutch. If, for example, in place of a planetary transmission 130, a spur wheel back-geared motor is used, the switchable brake 140 is developed as a clutch in such a way that an energy chain between spindle 110 and motor 150 is interrupted during inactive status.

However, if, on the other hand, a planetary transmission 130 is used; for example, a ring gear for a power transmission from motor 150 to spindle 110; running planetary wheels are braked in the ring gear.

The springs 291, 291 and 293 are arranged interpenetrating to develop a compact structure of the adjusting system. An additional case 800 can be provided for the interpenetration which avoids a friction of the springs 291, 292 and 293 and enables a sliding control. For this, the case 800 is arranged between two of the springs 291, 292 and 293 so that the springs 291, 292 and 293 and the case 800 are radially interpenetrating.

1. An adjusting system of a motor vehicle for the adjusting of a closing part, such as a rear flap, a trunk deck, a sliding or swinging door, for the closure of an opening of a motor vehicle body, the adjusting system comprising:
a first casing extending oblong in a length-wise direction,
a second casing extending oblong in the same length-wise direction, the second casing comprising a lesser cross section than the first casing, arranged at least partially within the first casing and adjustable in a length-wise direction,
a spindle for the relative adjustment of a first casing to the second casing which is arranged within at least one of the first casing and the second casing,
an electromotor and a transmission connected with at least one of the spindle and at the second casing,
at least one spring arranged within at least one of the first casing and second casing and operates length-wise, and
wherein one or the casings is attached on the side of the body and another of the casings is attached to the closing side.

2. The adjusting system according to claim 1 wherein the electro-motor and the transmission are at least partially attached within the first casing and against radial rotation opposite to the first casing.

3. The adjusting system according to claim 1, wherein the electro-motor and the transmission are at least partially arranged within the first casing and are attached against radial shifting opposite to the first casing.

4. The adjusting system according to claim 1, wherein a clutch or a brake is arranged within the first or second casing and is connected with at least one of the transmission and the electro-motor.

5. The adjusting system according to claim 4, wherein the braking effect of the brake can be cancelled either by a manual dynamic effect on the closing part or by electro-motor force of the electro-motor.

6. The adjusting system according to claim 1, wherein a sensory device for the sensation of the adjustment is attached at least one of the first and second casing and is effectively connected with a driving motion of the electro-motor.

7. The adjusting system according to claim 1, wherein at least one of the spindle and the transmission for a spindle rotation arranged to be driven by the electro-motor.

8. The adjusting system according to claim 1, wherein a spindle nut is arranged for the relative adjustment of the first casing to the second casing, one of the casings is connected stationary and axially with the spindle nut, and another of the casings is connected stationary and axially with the spindle.

9. The adjusting system according to claim 1, wherein a first end of the spring regarding the first casing is run on bearings stationary in length-wise direction and a second end of the spring regarding the second casing is run on bearings stationary in length-wise direction.

10. The adjusting system according to claim 1, wherein a bearing for the attachment of at least one of the first casing and second casing at the body or at the closing part, the bearing being a pivot or a drag bearing.

11. The adjusting system according to claim 1, wherein at least one power switch, is electrically connected with the electro-motor for the electro-motor's control and the at least one power switch is arranged within the first casing.

12. The adjusting system according to claim 11, wherein the at least one power switch is a power semiconductor.

13. The adjusting system according to claim 11, wherein the at least one power switch is thermally connected with the first casing so as to effect heat loss.
